(19) United States
(12) Patent Application Publication
(10) Pub. No.: US 2023/0147191 A1
(43) Pub. Date: May 11, 2023

(54) Fight Phone Case

(71) Applicant: William Schaffer, Oxford, MS (US)

(72) Inventor: William Schaffer, Oxford, MS (US)

(21) Appl. No.: 17/522,558

(22) Filed: Nov. 9, 2021

(51) Int. Cl. H04B 1/3888; A45C 11/00; A45C 15/00

(52) U.S. Cl. CPC H04B 1/3888; A45C 11/00; A45C 15/00; A45C 2011/002

(57) ABSTRACT

An article of manufacture for providing a self-defense cellular telephone case is disclosed.

### CROSS-REFERENCES TO RELATED APPLICATIONS

This application claims the benefit of provisional application No. 63/115,135 entitled FIGHT PHONE CASE, filed Nov. 18, 2020. The provisional application is incorporated in its entirety by reference.

### FIELD OF INVENTION

This application relates in general to an article of manufacture for providing a personal protection device, and more specifically, to an article of manufacture for providing a self-defense cellular telephone case.

### BACKGROUND OF THE INVENTION

Ordinary people may from time to time encounter individuals who present a threat of theft, mugging, assault, and injury while the ordinary people are out in public. Such encounters may occur is crowded cities, deserted small rural towns, highway rest stops, restaurants, and the like. Most ordinary people do not carry on their person an object that is intended to provide personal protection in these situations. As a result, ordinary people may become victims of a crime.

At the same time, most people carry a cellular phone for use at all times of the day wherever they may be. These same people may carry these cellular phones in a carrying case that protects the cellular phones from accidents that may damage the screens, cases, and electronics. Therefore, a need exists for an article of manufacture for providing a self-defense cellular telephone case.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

In one embodiment, the present invention is an article of manufacture for providing a self-defense cellular telephone case.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

The present invention is described in detail below with reference to the attached drawing figures, wherein:

FIG. 1 illustrates an example embodiment of an article of manufacture for providing a self-defense cellular telephone case according to the present invention.

FIG. 2 illustrates another example embodiment of an article of manufacture for providing a self-defense cellular telephone case according to the present invention.

FIG. 3 illustrates yet another example embodiment of an article of manufacture for providing a self-defense cellular telephone case according to the present invention.

FIG. 4 illustrates example embodiments of add-on devices used with an article of manufacture for providing a self-defense cellular telephone case according to the present invention.

### DETAILED DESCRIPTION OF THE INVENTION

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

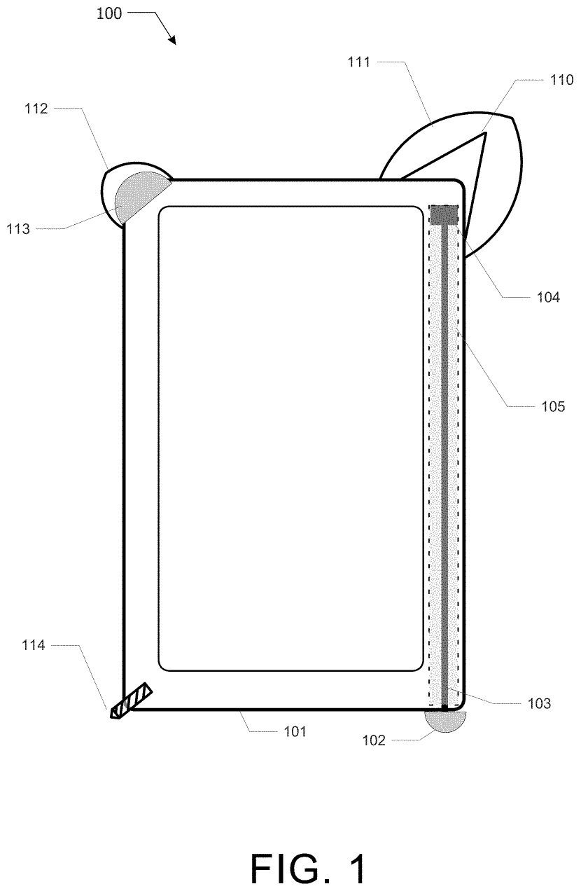

In general, the present disclosure relates to an article of manufacture for providing a personal protection device. To better understand the present invention, FIG. 1 illustrates an example embodiment for an article of manufacture for providing a self-defense cellular telephone case 100 according to the present invention. FIG. 1 shows a cell phone case 101 having one or more impact points 110-114 about its corners. These plurality of impact points 110-114 may be made of different materials, in different sizes, that may serve different self-defense functions. For example, these plurality of impact points 110-114 may include a large, sharp impact point 110, a large, rounded impact point 112, a small, rounded impact point 112 having a metal corner covering the case 113, and an elongated spike impact point 114.

The cell phone case 101 may also include an internal cord 103 having an external grip 102 on a first end and a stop device 103 on a second end. The internal cord 103 and stop device 104 are located within an internal shaft 105 running the length of the case 101. When a user pulls downward on the external grip 102, the internal cord 103 is pulled out of the internal shaft 105 with the stop device 104 moving the length of the internal shaft 105 until the stop device 104 engages the opening of the external shaft 105 in the case 101. With the internal cord 103 extended, the case 101 with the weight of the cellphone included becomes a defensive device on a cord that the user may swing about him or herself to keep a potential attacker away. The plurality of impact points 110-114 may also provide defensive value if a potential attacker is struck by one of them in addition to the case 101. In an embodiment of a base model of the cell phone case 101, a single impact point is affixed to the case along with the internal cord 103.

The case 101 may be made of a hard plastic, metal, or any other solid material that both protects a cell phone within the case 101 as well as provides enough mass to make the case a self-defense device. The case 101 also may be made of a combination of materials to add both additional strength and weight to the case 101. The internal cord 103 may be made of paracord, cable, rope, string, bungie, string, and elastic material among others. The internal cord 103 should be strong enough to allow the case 101 to be swung about as a weapon without breaking and light enough to slide easily within the internal shaft 105. The internal shaft 105 consists of a solid slide tube having an internal stop at the opening out of the case. The solid tube may be a sleeve-like tube inserted within the case material and may, in an alternate embodiment, be a shaft through the case material. The stop device 104 may be a bead, a knot in the cord, or similar solid device that is small enough to fit within and slide the length of the internal shaft 105, while being large enough to hold the case against the stop device 104 when it engages the internal stop at the opening of the internal shaft 105 in the case 101. The external grip 102 may engage the case 101 about the opening to the internal shaft 105 that allows the grip to click into place when not in use while permitting it to easily disengage from the case when needed.

The plurality of impact points 110-114 may be of many shapes as disclosed herein. These impact points may provide a sharp point 110 that provides a pointed eye device. The impact point may provide large 111 and small 112 blunt striking devices. The impact points also may include a plurality of optional accessories such as the elongated spike 114 that is screwed into the case 101. Such accessories also may include glass breaking devices and material cutting devices.

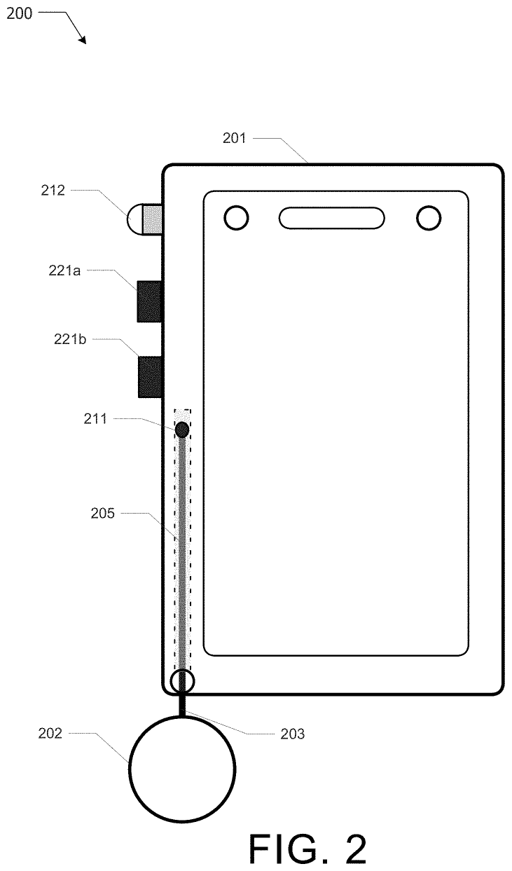

FIG. 2 illustrates another example embodiment of an article of manufacture for providing a self-defense cellular telephone case 200 according to the present invention. FIG. 2 shows a back side of a case 201 along a keyring 202 for the external grip that is attached to the internal cord 203 within the internal shaft 205. The stop device 211 is shown as a sphere-like bead as compared to a cube or cylindrical device 104 as shown in FIG. 1. In this embodiment, the impact point 212 is shown on a side of the case about but not exactly at, a corner of the case 201. These impact points 212 may be fixed or removable to allow different devices to be part of the case 201.

The internal shaft 205 may be arranged or made to allow any user control buttons 221a-b on the cell phone to protrude through the case 201 permitting them to be manipulated by a user. These user control buttons 221a-b also may be thinly covered by case material rather than protrude through an opening in the case if the covering material is thin and flexible enough to permit the user to still manipulate the user control buttons 221a-b while covered. Because of this need, the internal shaft 205 may be located on either side of the case 201 should a particular model of cell phone have fewer or no buttons on one side of the cell phone. The key ring 202 may, of course, be made in any shape or may be a similar device with other purposes.

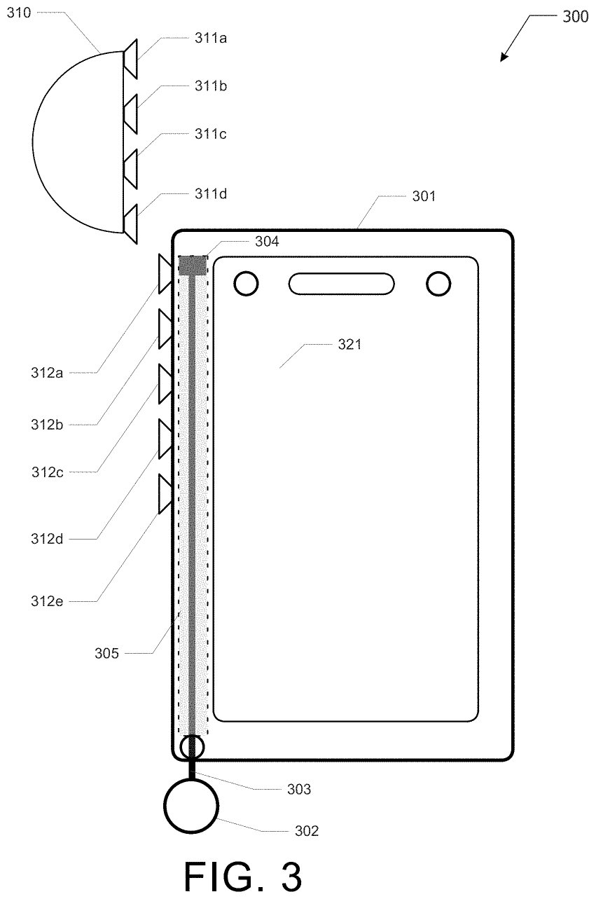

FIG. 3 illustrates an example embodiment of an article of manufacture for providing a self-defense cellular telephone case 300 according to the present invention. FIG. 3 shows a back side of a case 301 along a keyring 302 for the external grip that is attached to the internal cord 303 and stop device 304 within the internal shaft 305. In this embodiment, a removable impact point 310 is shown adjacent to and slightly above the case 301. The removable impact point 310 has a plurality of attachment devices 311a-d that engage a mating set of attachment devices 312s-e on the outside edge of the case 301. Each of the attachment mechanisms are sized and shaped to fit within the openings between the mating attachment devices on the corresponding device. In this embodiment, these mating attachment devices are shaped similar to a set of picatinny rail joints that permit two objects to be securely joined together in which the joint is shaped to hold the objects in place. A tightening screw is used to affix any attachments. Of course, one of ordinary skill may recognize that other attachment mechanisms may be used in place of these mating attachment devices 311a-d, 312a-e.

As with all of the embodiments disclosed herein, the case 301 has an internal cavity 321 that is sized and shaped to hold a particular cell phone. Versions of the case 301 may be required for each different model of cell phone from various manufacturers to permit the internal cavity 321 to match the external dimensions of the particular cell phone.

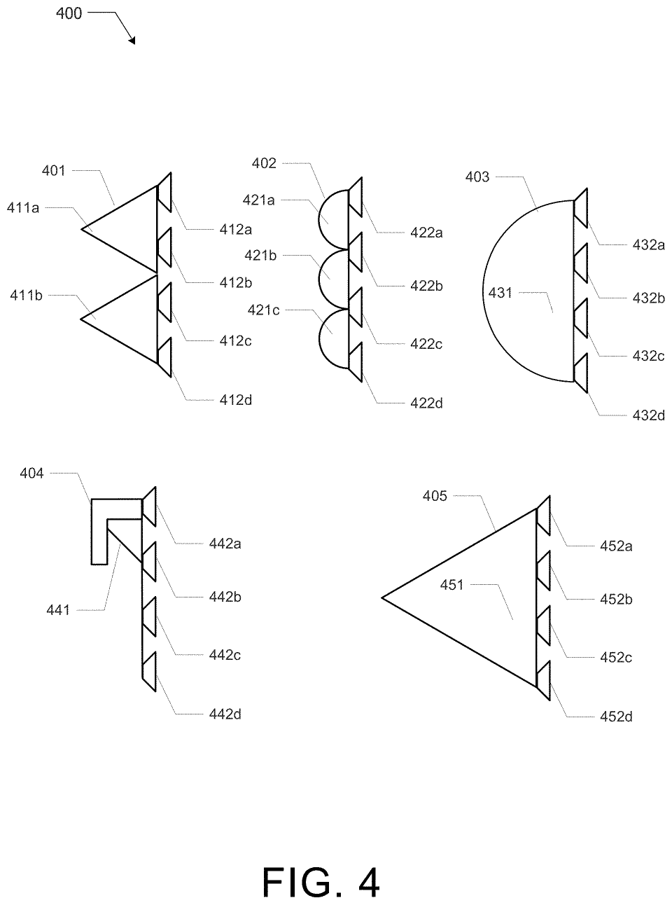

FIG. 4 illustrates example embodiments of add-on devices used with an article of manufacture for providing a self-defense cellular telephone case according to the present invention. FIG. 4 shows five different impact points 401-405, each having a different shape and function. All of these impact points 401-405 include attachment devices 412a-d, 422a-d, 432a-d, 442a-d, 452a-d that may mate with matching attachment devices 312a-e as shown in FIG. 3.

The first embodiment of an impact point 401 has a pair of pointed spikes 411a-b that are made of hard plastic. This impact point 401 may inflict harm upon a potential attacker when the case 301 is used as a weapon. The impact point 401 connects to a case 301 using attachment devices 412a-d coupling with mating attachment devices 312a-e.

The second embodiment of an impact point 402 consists of a plurality of smaller, rounded impact points 421a-c. The impact point 402 is made of hard plastic over metal. The impact point 402 connects to a case 301 using attachment devices 422a-d coupling with mating attachment devices 312a-e.

The third embodiment of an impact point 403 consists of a single large, rounded impact point 431. The impact point 402 is made of hard plastic over metal. The impact point 402 connects to a case 301 using attachment devices 432a-d coupling with mating attachment devices 312a-e.

The fourth embodiment of an impact point 404 consists of a single, web-cutting sharp blade impact point 441. The impact point 404 is made of hard plastic over metal. The impact point 404 connects to a case 301 using attachment devices 442a-d coupling with mating attachment devices 312a-e.

The fifth embodiment of an impact point 405 consists of a large, single pointed spike impact point 451. The impact point 405 is made of hard plastic over metal and has a carbine tip for breaking glass. The impact point 405 connects to a case 301 using attachment devices 452a-d coupling with mating attachment devices 312a-e.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

What is claimed is:

1. A self-defense cellular telephone case comprising:
a cell phone case having one or more impact points and an internal shaft; and
an internal cord housed in the internal shaft, the internal cord having an external grip.

2. The self-defense cellular telephone case of independent claim 1, wherein:
at least one of the one or more impact points in located at a corner of the cell phone case.

3. The self-defense cellular telephone case of independent claim 1, wherein:
at least one of the one or more impact points in located at a side of the cell phone case.

4. The self-defense cellular telephone case of independent claim 1, wherein:
at least one of the one or more impact points comprises a large, sharp impact point.

5. The self-defense cellular telephone case of independent claim 1, wherein:
at least one of the one or more impact points comprises a large, rounded impact point.

6. The self-defense cellular telephone case of independent claim 1, wherein:
at least one of the one or more impact points comprises a small, rounded impact point having a metal corner covering the cell phone case.

7. The self-defense cellular telephone case of independent claim 1, wherein:
at least one of the one or more impact points comprises an elongate, spike impact point.

8. The self-defense cellular telephone case of independent claim 1, wherein:
at least one of the one or more impact points comprises of a single, web-cutting sharp blade.

9. The self-defense cellular telephone case of independent claim 1, wherein:
the internal chord comprises at least one of paracord, cable, rope, string, bungie, string, and elastic material.

10. The self-defense cellular telephone case of independent claim 1, wherein:
the external grip comprises a keyring.

11. The self-defense cellular telephone case of independent claim 1, wherein:
at least one of the one or more impact points is removably attached to the cell phone case.
